(19) United States
(12) Patent Application Publication
(10) Pub. No.: US 2025/0068997 A1
(43) Pub. Date: Feb. 27, 2025

(54) SYSTEMS AND METHODS FOR AUTOMATICALLY GROUPING TASK RECORDS USING A MACHINE LEARNING MODEL

(71) Applicant: Cognitive Automation Technologies, Inc., Newark, DE (US)

(72) Inventor: Benjamin Projdakov, Berlin (DE)

(21) Appl. No.: 18/454,302

(22) Filed: Aug. 23, 2023

(51) Int. Cl. G06Q 10/0631; G06Q 10/10

(52) U.S. Cl. CPC G06Q 10/063112; G06Q 10/063114; G06Q 10/103; G06Q 50/184

(57) ABSTRACT

Systems and methods for automatically grouping task records using a machine learning model are disclosed. Exemplary implementations may: obtain model training information; train a model using the model training information to generate a trained model; store the trained model in non-transitory electronic storage; provide user information associated with individual users and record information from individual task records as input for the trained model; obtain the output from the trained model; and generate, from the output, grouping information for the task records, the grouping information defining individual sets of one or more users to be associated with individual task records.

### FIELD OF THE DISCLOSURE

The present disclosure relates to systems and methods for automatically grouping task records using a machine learning model.

### BACKGROUND

Web-based record management environments may enable users to track progress toward completion and/or costs of projects, tasks, or other assignments to assignees (e.g., users) to complete. A record management environment may comprise an environment in which individual users and/or a virtual team of users does its work and enables the users to track the work in a more organized and efficient manner for the users.

### SUMMARY

Assigning projects, tasks, or other assignments to individual users within record management environments poses many challenges. For example, assignment of projects, tasks, and/or other assignments is generally done manually. Manual assignment requires one or more users assigning the tasks to determine who is best to complete the job based on current workloads of users, experience of users, skill level of users, eligibility of users for particular tasks, and/or other information. Manually managing such factors may result in poor and/or inefficient assignment of individual projects, tasks, and/or other assignments. One way that operators look to improve the operation of the record management environments is to improve assignment of projects, tasks, or other assignments to individual users. For example, assignment of projects, tasks, or other assignments may be improved by enabling automatic assignment of projects, tasks, or other assignments. Automatic assignment of projects, tasks, or other assignments may enable more efficient assignments based on a variety of factors of users being assigned. For example, automatic assignment may enable an amount of time of activity necessary to complete individual projects, tasks, and/or other assignments to be minimized, maximized, and/or averaged. For example, automatic assignment may enable a cost of completion of individual projects, tasks, and/or other assignments to be minimized, maximized, and/or averaged.

To address these and/or other problems, one or more implementations presented herein propose a technique to automatically group task records. Individual task records may characterize individual tasks managed, created, and/or assigned within a record management environment. A task may be a unit of work. One or more implementations may propose a machine learning model specifically trained to group task records. The model may be trained based on training information. In some implementations, training information may be stored in non-transitory electronic storage media. The training information may include training input data and training output data. Training input data may include user information associated with individual users and record information from individual task records characterizing individual tasks. In some implementations, the user information may include information from existing user records that have been managed within a record management environment. In some implementations, user information associated with an individual user may include one or more of a title of the individual user, information characterizing experience of the individual user, and/or other information. In some implementations, the record information may include information from existing task records that were previously manually assigned to one or more users and/or other information. In some implementations, record information from an individual task record characterizing an individual task may include one or more of beneficiary information, matter identification information, information identifying one or more users associated with the individual task, an amount of time of activity toward completion of the individual task by an individual user, a duration of the individual task, and/or other information. Training output data may include amounts of time of activity associated with completion of individual task by individual users completing the individual tasks.

One or more aspects of the present disclosure may relate to training a machine learning model to group task records. Training a machine learning model to group task records may include a system configured to training the machine learning model. The system may be configured to obtain model training information. The system may be configured to train a model using the model training information to generate a trained model. In some implementations, the training input data may be input to the machine learning model during training. In some implementations, the training output data may be output by the machine learning model during training. The trained model may be configured to output predicted amounts of time of activity associated with completion of individual tasks by individual users completing the individual tasks. The system may be configured to store the trained model in non-transitory electronic storage.

One or more aspects of the present disclosure may relate to a system configured to automatically group task records. The system may be configured to manage environment state information maintaining a record management environment. The record management environment may be configured to facilitate interaction by users with the record management environment. The environment state information may include user information associated with individual users and record information from individual task records. The system may be configured to provide the user information associated with the individual users and the record information from the individual task records as input for the trained machine learning model. The system may be configured to obtain the output from the trained model. The system may be configured to generate grouping information for the task records. In some implementations, the grouping information may define individual sets of one or more users to be associated with individual task records. In some implementations, the grouping information may be determined based on the output amounts of time and one or more of a subset of the user information and a subset of the record information.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to automatically group task records using a machine learning model, in accordance with one or more implementations.

FIG. 2A illustrates a method for training a machine learning model to group task records, in accordance with one or more implementations.

FIG. 2B illustrates a method for automatically grouping task records using a machine learning model, in accordance with one or more implementations.

FIG. 3 illustrates an exemplary user interface depicting an exemplary task record, in accordance with one or more implementations.

FIG. 4 illustrates an exemplary user interface depicting an exemplary user record, in accordance with one or more implementations.

### DETAILED DESCRIPTION

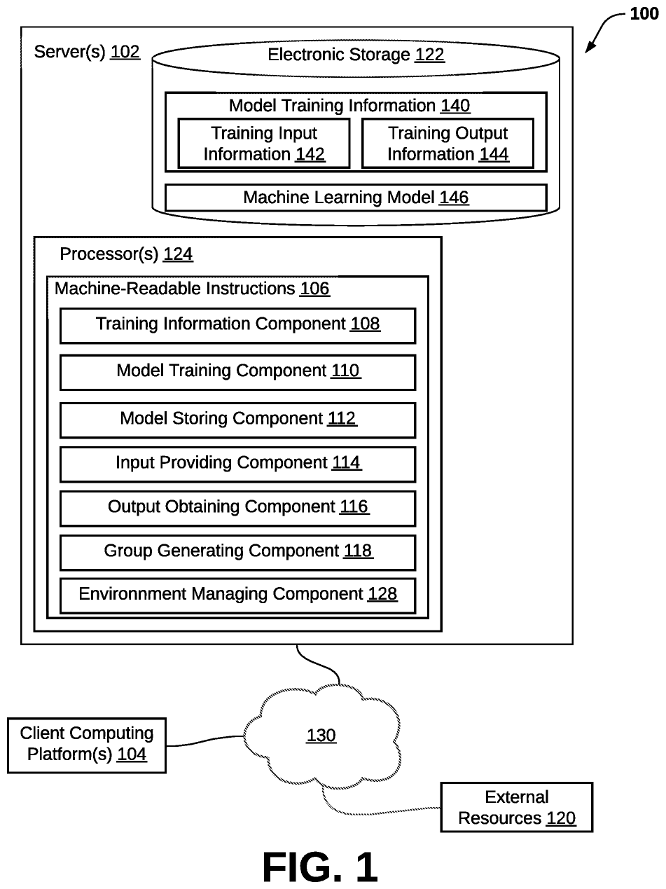

FIG. 1 illustrates a system 100 configured to automatically group task records using a machine learning model, in accordance with one or more implementations. In some implementations, the task records may be managed by a record management environment. In some implementations, system 100 may include one or more servers 102. Server(s) 102 may be configured to communicate with one or more client computing platforms 104 according to a client/server architecture, a peer-to-peer architecture, and/or other architectures. Client computing platform(s) 104 may be configured to communicate with other client computing platforms via server(s) 102 and/or according to a client/server architecture, a peer-to-peer architecture, and/or other architectures. Users may access system 100 and/or instances of the record management environment via client computing platform(s) 104. Server(s) 102 may be remote from client computing platform(s) 104. Client computing platform(s) 104 may be remote from each other.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Electronic storage 122 may be configured to store model training information 140, machine learning model 146, and/or other information. Training information 140 may include training input information 142, training output information 144, and/or other information. In some implementations, training information 140 may include record information from individual task records, user information associated with individual users, and/or other information.

Server(s) 102 may be configured by machine-readable instructions 106. Machine-readable instructions 106 may include one or more instruction components. The instruction components may include computer program components. The instruction components may include one or more of training information component 108, model training component 110, model storing component 112, input providing component 114, output obtaining component 116, group generating component 118, environment management component 128, and/or other instruction components.

Environment management component 128 may be configured to manage environment state information maintaining a record management environment. The record management environment may be configured to facilitate interaction by users with the record management environment. The environment state information may include user information associated with individual users and record information from individual task records. Individual task records may characterize individual tasks managed, created, and/or assigned within the record management environment. A task may be a unit of work. In some implementations, user information may correspond to and/or be included in individual user records.

Record information from an individual task record characterizing an individual task may include one or more of matter identification information, beneficiary information, information characterizing an objective of the individual task, a type of the individual task, association information, an amount of time of activity toward completion of the individual task by an individual user, a duration of the individual task, a cost of the individual task, and/or other information. In some implementations, matter identification information may identify an individual matter associated with an individual task. By way of non-limiting example, the individual matter may define an affair or situation which the individual task concerns. For example, an individual matter may be associated with prosecution of an individual patent application. For example, individual tasks associated with the individual matter may include one or more of preparing a patent application, filing a patent application, responding to a rejection associated with the patent application, and/or other tasks associated with prosecution of a patent application.

By way of non-limiting example, a type of an individual task may characterize a format and/or general goal of an individual task. For example, a type of an individual task associated with the individual task may denote the type of the individual task includes responding to a non-final rejection, another general goal of the individual task, and/or another format of the individual task. In some implementations, association information may include information identifying one or more users associated with the individual task. By way of non-limiting example, association information may include information identifying no users are associated with the individual task when no users are associated with the individual task.

In some implementations, beneficiary information may identify one or more beneficiaries associated with an individual matter and/or task. In some implementations, a beneficiary may be an entity associated with an individual matter and/or task. In some implementations, a beneficiary associated with an individual matter and/or task may benefit from completion of the individual matter and/or task and/or may have initiated progress toward completion of the individual matter and/or task. By way of non-limiting example, an individual matter and/or task may be associated with prosecution of a patent application for an invention. For example, one or more beneficiaries associated with the individual matter and/or task may include one or more of an inventor of the invention, an assignee of the patent application, a company associated with the patent application and/or the invention, and/or another entity associated with completion of prosecution of the patent application.

In some implementations, duration of an individual task may characterize an amount of time between assignment of the individual user to one or more users and completion of the individual task by the one or more users. In some implementations, duration of an individual task may include and/or be determined based on a start date of the task and an end date of the individual task. In some implementations, an amount of time of activity toward completion of an individual task by an individual user may be determined based on tracked activity via one or more client computing platforms 104 associated with the individual user. In some implementations, the activity may be tracked manually and/or automatically. By way of non-limiting example, a user of system 100 may manually log an amount of time of activity of one or more users in association with one or more tasks via one or more client computing platforms 104. Environment managing component 128 may be configured to update record information and/or user information based on the logged amount of time.

By way of non-limiting example, an amount of time of activity may be tracked automatically based on activity by an individual user via one or more client computing platforms 104 associated with the individual user. In some implementations, the amount of time of may be associated with an individual matter and/or task by virtue of an individual user associating the activity with the individual matter and/or task and/or by virtue of the activity automatically being determined to be associated with the individual matter and/or task. In some implementations, activity tracked via one or more client computing platforms 104 may be characterized as active and/or passive activity. In some implementations, activity may be characterized as active responsive to one or more client computing platforms 104 receiving input by an individual user within a particular amount of time and/or at or below a particular frequency. By way of non-limiting example, input received via one or more client computing platforms 104 may include one or more of a mouse movement, a button press, a cursor movement, one or more words entered, file activity, and/or other inputs. By way of non-limiting example, activity tracked may include information characterizing a button pressed, a word entered, a time of activity, a duration of activity, open file information, open webpage information (e.g., a uniform resource locator), and/or other information. By way of non-limiting example, tracked activity may be characterized as active responsive to one or more client computing platforms 104 receiving input by an individual user within the last 10 seconds, 30 seconds, 5 seconds, 1 minute, and/or another amount of time. For example. active activity may be determined responsive to a user typing via one or more client computing platforms 104. For example, passive activity may be determined responsive to a user reading via one or more client computing platforms 104. Environment managing component 128 may be configured to update record information and/or user information based on the tracked activity.

In some implementations, cost information of an individual task may include a cost associated with one or more users completing the individual task, a cost associated with completion of the individual task, a cost associated with an amount of time of activity toward completion of the individual task by one or more users, and/or other information affecting a cost associated with the individual task. By way of non-limiting example, a cost may be an amount of time, a monetary value, and/or another type of expense. By way of non-limiting example, a monetary value of an amount of time of activity by an individual user may be determined based on cost information included in user information for a user record associated with the individual user. By way of non-limiting example, a monetary value associated with completion of the individual task by an individual user may be determined based on cost information included in user information for a user record associated with the individual user. By way of non-limiting example, a cost associated with an amount of time of activity toward completion of the individual task and/or a cost associated with completion of the individual task may be determined and/or managed by the record management environment. By way of non-limiting example, a cost associated with completion of the individual task may be determined based on a type of the individual task, a beneficiary of the individual task, a matter associated with the individual task, an objective of the individual task, a duration of the individual task, and/or other information.

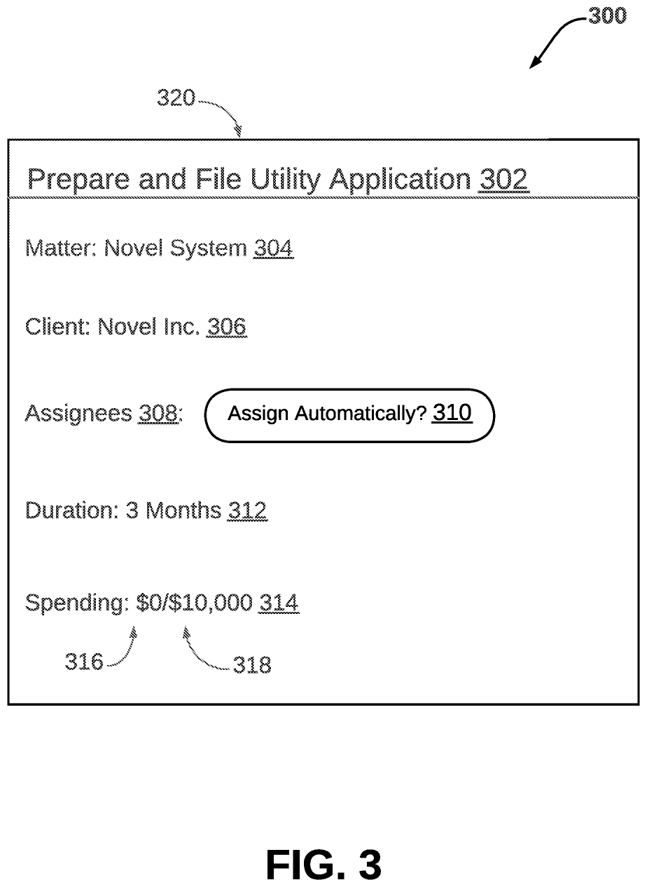

By way of non-limiting example, FIG. 3 depicts an exemplary user interface 300 depicting a task record 320 characterizing a task. By way of non-limiting example, record information for task record 320 may include a type 302, matter identification information 304, beneficiary identification information 306, association information 308, a duration 312, and cost information 314. Beneficiary identification information 306 may identify a client named “Novel Inc.” By way of non-limiting example, Novel Inc. may have initiated progress toward completion of the task characterized by task record 320 and/or may benefit from completion of the task characterized by task record 320. By way of non-limiting example, association information 308 may identify assignees of task record 320. Association information 308 may not identify any users assigned to task record 320 by virtue of no users being assigned to task record 320. User interface 300 may include a button 310. Interaction with button 310 via a client computing platform may trigger assignment of task record 302 to one or more users. Cost information 314 may include a spent amount 316 and a budget 314. By way of non-limiting example, spent amount 316 may identify an amount of money that has been used toward completion of the task characterized by task record 320. By way of non-limiting example, spent amount 316 may be determined based on activity and/or amounts of time of activity toward completion of the task. In some implementations, duration 312 may indicate an amount of time that has elapsed since initiation of the task and/or an amount of time between initiation of the task and a due date of the task.

Returning to FIG. 1, in some implementations, the user information may include information from existing user records that have been and/or are managed within a record management environment. By way of non-limiting example, user information associated with an individual user may include one or more of a title of the individual user, information characterizing experience of the individual user, a cost associated with an individual unit of time of activity toward completion of individual tasks, a cost associated with completion of an individual task by the individual user, beneficiary association information, performance information, and/or other information. By way of non-limiting example, a cost associated with an individual unit of time of activity toward completion of individual task by the individual user may include an hourly rate, a per minute rate, a daily rate, and/or a rate associated with another unit of time of activity of the individual user. For example, a cost associated with completion of an individual task by the individual user may include a flat rate associated with individual task. In some implementations, the flat rate may be associated with a type of the individual task and/or other record information associated with a task record for the individual task. By way of non-limiting example, beneficiary association information may identify one or more entities associated with an individual user and/or activity to be completed by the individual user, one or more entities not to be associated with an individual user and/or activity to be completed by the individual user, and/or other information.

In some implementations, performance information may characterize quality of work completed by individual users for individual units of work. Performance information may include a rating of units of work completed by the individual user and/or other information. In some implementations, the rating of units of work may be determined manually, automatically, and/or in another way. By way of non-limiting example, the rating of units of work may be determined manually by another user, by a beneficiary, and/or by another entity. By way of non-limiting example, the rating of units of work may be determined automatically by a computer system and/or another system. For example, the computer system may count typos, count grammatical errors, determine whether a body of text is written professionally, and/or otherwise characterize a rating of units of work.

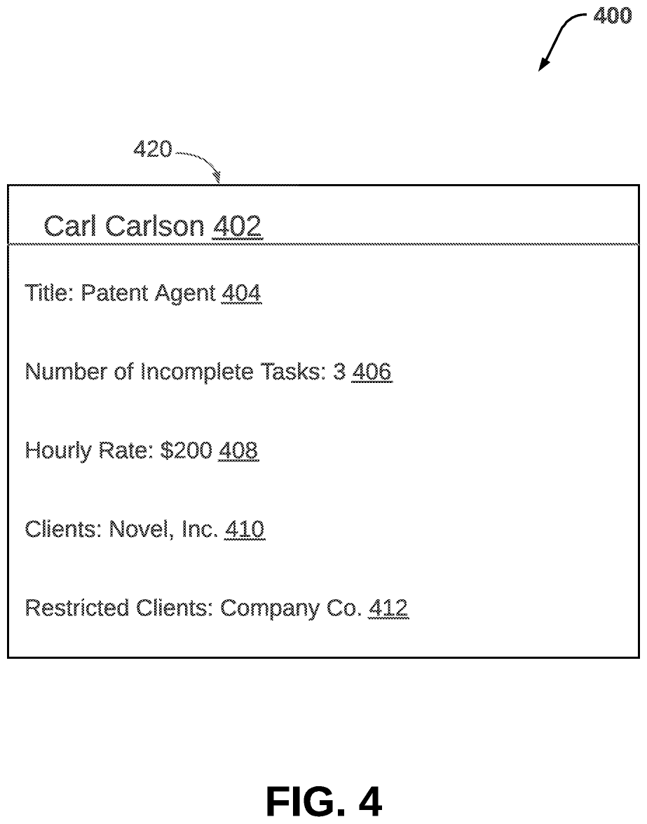

By way of non-limiting example, FIG. 4 depicts an exemplary user interface 400 depicting a user record 420 associated with a user. User interface 400 may display user information corresponding to user record 420. The user information may include a name 402 of the user, a title 404 of the user, a number of incomplete tasks 406, an hourly rate 408, a list of clients 410, and a list of restricted clients 412. By way of non-limiting example, the number of incomplete tasks 406 may be a number of tasks assigned to the user but not yet completed. In some implementations, hourly rate 408 may be a cost associated with an individual unit of time of activity toward completion of individual tasks by the user. By way of non-limiting example, the user may be associated with “Novel, Inc.” by virtue of “Novel, Inc.” being included in list of clients 410. By way of non-limiting example, the user may not be associated with “Company Co.” by virtue of “Company Co.” being included in list of restricted clients 412. In some implementations, individual items of list of clients 410 and list of restricted clients 412 may be identified in beneficiary association information included in user information corresponding to user record 420.

Training information component 108 may be configured to obtain model training information 140. In some implementations, model training information 140 may be obtained in and/or from electronic storage 122. By way of non-limiting example, obtaining model training information 140 may include obtaining training input information 142 and training output information 144 in and/or from electronic storage 122. In some implementations, training input information 142 may be a subset of model training information 140. Training input information 142 may include the user information associated with the individual users, the record information from the individual task records characterizing individual tasks, and/or other information. In some implementations, training output information 144 may be a subset of model training information 140. Training output information 144 may include amounts of time of activity associated with completion of individual users completing the individual tasks and/or other information. In some implementations, training output information 144 may be a subset of record information from the individual task records.

In some implementations, the training information may include information from existing task records that have been and/or are managed within a record management environment. In some implementations, individual ones of the existing task records may have been previously manually and/or automatically assigned to one or more users. By way of non-limiting example, a first task record may have a first assignee and a second assignee. For example, the first assignee may have been manually assigned to the first task record by themselves, another user, and/or another person. For example, the second user may have been automatically assigned to the first record by a system maintaining the record management environment and/or another system. In some implementations, an individual task record being assigned to an individual user may include associating an individual task record with an individual user record associated with the individual user within the record management environment. By way of non-limiting example, an individual user assigned to an individual task record may complete and/or effect progress toward completion of an individual task associated with the individual task record.

Model training component 110 may be configured to train a model using model training information 140. In some implementations, training the model may generate a trained model. In some implementations, the trained model may be the same as machine learning model 146. Machine learning model 146 may be configured to output predicted amounts of time of activity associated with completion of individual tasks by individual users completing the individual tasks. By way of non-limiting example, a predicted amount of time of activity associated with completion of an individual task may be an amount of time of activity by one or more users that may be expected for the one or more users to complete the individual task. In some implementations, machine learning model 146 may be configured for clustering, time series forecasting, regression, classification, and/or other machine learning techniques.

Model training component 110 may be configured to train the model until the model achieves a desired level of accuracy on the training information. In some implementations, machine learning model 146 may utilize one or more of an artificial neural network, long short-term memory (LSTM) network architecture, a recurrent neural network architecture, a feedforward neural network architecture, a random forest architecture, a gradient boosting regressor architecture, a time delay neural network architecture, naïve bayes classifier algorithm, k-means clustering algorithm, support vector machine algorithm, linear regression, logistic regression, decision trees, random forest, nearest neighbors, and/or other approaches. Model training component 110 may utilize training techniques such as deep learning. Model training component 110 may utilize training techniques such as one or more of supervised learning, semi-supervised learning, unsupervised learning, reinforcement learning, and/or other techniques.

In supervised learning, the model may be provided with a known training dataset that includes desired inputs and outputs, and the model may be configured to find a method to determine how to arrive at those outputs based on the inputs. The model may identify patterns in data, learn from observations, and make predictions. The model may make predictions and may be corrected or validated by an operator-this process may continue until the model achieves a high level of accuracy/performance. Supervised learning may utilize approaches including one or more of classification, regression, and/or forecasting.

Semi-supervised learning may be similar to supervised learning, but instead uses both labelled and unlabeled data. Labelled data may comprise information that has meaningful tags so that the model can understand the data, while unlabeled data may lack that information. By using this combination, the machine learning model may learn to label unlabeled data.

Reinforcement learning may focus on regimented learning processes, where the machine learning model may be provided with a set of actions, parameters, and/or end values. By defining the rules, the machine learning model then tries to explore different options and possibilities, monitoring and evaluating each result to determine which one is optimal. Reinforcement learning teaches the model trial and error. The model may learn from past experiences and begin to adapt its approach in response to the situation to achieve the best possible result.

In some implementations, using model training information 140 may include using training input information 142 and training output information 144. By way of non-limiting example, training the model may include providing training input information 142 as input to the model during training. By way of non-limiting example, in supervised learning, training output information 144 may include desired outputs of machine learning model 146. By way of non-limiting example, in semi-supervised learning, training output information 144 may include labels corresponding to information included in training input information 142.

Model storing component 112 may be configured to store the trained model in non-transitory electronic storage 122. By way of non-limiting example, storing the trained model may include storing machine learning model 146 in non-transitory electronic storage 122. In some implementations, storing machine learning model 146 may enable the trained model to be used with new inputs.

Input providing component 114 may be configured to provide user information associated with individual users and record information from individual task records as input for the trained model. In some implementations, the individual tasks associated with the individual task records may be incomplete. For example, record information from a first task record characterizing a first task may not include an amount of time of activity toward completion of the first task by an individual user. In some implementations, record information from the first task record may not include an amount of time of activity due to the first task being incomplete. For example, a second task record characterizing a second task may include one or more amounts of time of activity toward completion of the individual task. By virtue of the second task being incomplete, the one or more amounts of time of activity may have been insufficient for completion of the second task.

Output obtaining component 116 may be configured to obtain the output from machine learning model 146. In some implementations, obtaining the output for the trained model may include obtaining predicted amounts of time of activity associated with completion of individual tasks by the individual users completing the individual tasks.

Group generating component 118 may be configured to generate, from the output, grouping information for the task records. By way of non-limiting example, the grouping information may define individual sets of one or more users to be associated with individual task records. For example, the grouping information may identify a set of one or more users to be assigned to an individual task characterized by an individual one of the task records. The grouping information may be determined based on one or more of the output amounts of time, a subset of the user information, and/or a subset of the record information. In some implementations, inclusion of an individual user in an individual set of one or more users to be associated with an individual task may be determined based on individual ones of the subset of the user information, individual ones of the subset of the record information, a number of incomplete tasks assigned to the individual user, task completion information of the individual user, expected task completion information for the individual user, and/or other information.

By way of non-limiting example, the subset of the user information may include beneficiary association information and/or other information. For example, a first user record including first beneficiary association information may be associated with a first user and a second user record including second beneficiary association information may be associated with a second user. The first beneficiary association information may identify a first beneficiary associated with the first user. The second beneficiary association information may identify the second user is not to be associated with the first beneficiary. First record information characterizing a first task may include first beneficiary information identifying the first beneficiary is associated with the first task. Grouping information for the first task may include a first set of one or more users to be associated with the first task record. By way of non-limiting example, the first set of one or more users may include the first user based on the output from machine learning model 146 and/or first beneficiary association information included in the first user information. By way of non-limiting example, the first set of one or more users may not include the second user based on the output from machine learning model 146 and/or second beneficiary association information included in the second user information. In some implementations, the subset of the user information may include one or more of a title of the individual user, information characterizing experience of the individual user, a cost associated with an individual unit of time of activity toward completion of individual tasks, a cost associated with completion of an individual task by the individual user, beneficiary association information, and/or other information included in user information.

In some implementations, an individual set of one or more users defined by grouping information for an individual task record may be determined such that a predicted amount of time of activity associated with completion of the individual task by the one or more users included in the individual set of one or more users may be minimized, maximized, and/or averaged. In some implementations, group generating component 108 may be configured to generate individual predicted costs of completion of individual tasks based on the predicted amounts of time and the grouping information. For example, a predicted cost of completion of an individual task may be generated in accordance with individual costs associated with amounts of time of activity toward completion of the individual task by individual users identified by the grouping information. In some implementations, a predicted cost of completion of an individual task may be determined based on a workload of individual users identified by the grouping information, an average workload of users identified by the grouping information, and/or other information. For example, automatic assignment may enable a time of completion of individual projects, tasks, and/or other assignments to maintain an average time of completion. In some implementations, an individual set of one or more users defined by grouping information for an individual task record may be determined such that a predicted cost of completion of the individual task may be minimized, maximized, and/or averaged.

In some implementations, an individual set of one or more users defined by grouping information for an individual task record may be determined such that productivity of a group is optimized. By way of non-limiting example, the group may include a subset of the users of system 100. By way of non-limiting example, an optimal user for association with an individual task record may be associated with one or more of a minimum predicted cost of completion of the individual task associated with the individual task record, a minimum predicted time of activity toward completion of the individual task, a minimum predicted duration from associated with the individual task record to completion of the individual task, and/or other factors. By way of non-limiting example, an optimal user for association with an individual task record may be associated with one or more of a maximum predicted cost of completion of the individual task associated with the individual task record, a maximum predicted time of activity toward completion of the individual task, a maximum predicted duration from associated with the individual task record to completion of the individual task, and/or other factors. By way of non-limiting example, maximizing productivity of the group may include not associating the optimal user with the individual task record by virtue of the optimal user being associated with another task record. In some implementations, the grouping information may be generated in accordance with semantic analysis of text transcription and/or audio recordings of interactions between individual ones of the users and individual beneficiaries.

In some implementations, server(s) 102, client computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 120 may be operatively linked via some other communication media.

A given client computing platform 104 may include one or more processors configured to execute computer program components. The computer program components may be configured to enable an expert or user associated with the given client computing platform 104 to interface with system 100 and/or external resources 120, and/or provide other functionality attributed herein to client computing platform(s) 104. By way of non-limiting example, a given client computing platform 104 and/or a given server 102 may include one or more of a server, a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute components 108, 110, 112, 114, 116, 118, and/or 128, and/or other components. Processor(s) 124 may be configured to execute components 108, 110, 112, 114, 116, 118, and/or 128, and/or other components by software; hardware; firmware; some combination of software, hardware, and/or firmware; and/or other mechanisms for configuring processing capabilities on processor(s) 124. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, and/or 128 are illustrated in FIG. 1 as being implemented within a single processing unit, in implementations in which processor(s) 124 includes multiple processing units, one or more of components 108, 110, 112, 114, 116, 118, and/or 128 may be implemented remotely from the other components. The description of the functionality provided by the different components 108, 110, 112, 114, 116, 118, and/or 128 described below is for illustrative purposes, and is not intended to be limiting, as any of components 108, 110, 112, 114, 116, 118, and/or 128 may provide more or less functionality than is described. For example, one or more of components 108, 110, 112, 114, 116, 118, and/or 128 may be eliminated, and some or all of its functionality may be provided by other ones of components 108, 110, 112, 114, 116, 118, and/or 128. As another example, processor(s) 124 may be configured to execute one or more additional components that may perform some or all of the functionality attributed below to one of components 108, 110, 112, 114, 116, 118, and/or 128.

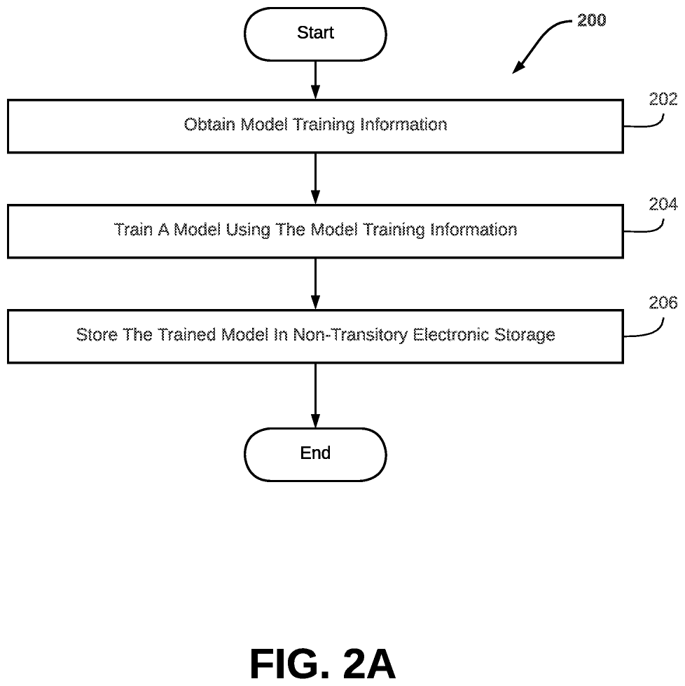

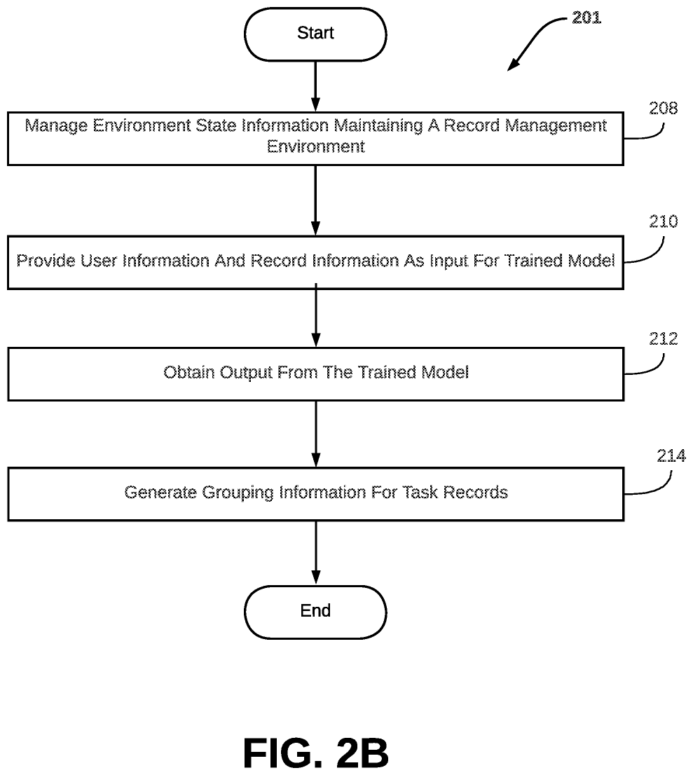

FIG. 2A illustrates a method 200 for automatically grouping task records using a machine learning model, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2A and described below is not intended to be limiting.

FIG. 2B illustrates a method 201 for automatically grouping task records using a machine learning model, in accordance with one or more implementations. The operations of method 201 presented below are intended to be illustrative. In some implementations, method 201 may be accomplished with one or more additional operations not described, and/or without one or more of the operations discussed. Additionally, the order in which the operations of method 201 are illustrated in FIG. 2B and described below is not intended to be limiting.

In some implementations, methods 200 and 201 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200. In some implementations, some or all of the operations of method 201 depicted in FIG. 2B may be performed after and/or at the same time as the operations of method 200 depicted in FIG. 2A.

Regarding method 200 (depicted in FIG. 2A), an operation 202 may include obtaining model training information. The model training information may include user information associated with individual users and record information from individual task records. Operation 202 may be performed by one or more hardware processors configured by machine-readable instructions including a component that is the same as or similar to training information component 108, in accordance with one or more implementations.

An operation 204 may include training a model using the model training information to generate a trained model. The trained model may be configured to output predicted amounts of time of activity associated with completion of individual tasks by individual users completing the individual tasks. The training input information may include the user information associated with the individual users and the record information from the individual task records characterizing individual tasks. The training output information may include amounts of time of activity associated with completion of individual users completing the individual tasks. Operation 204 may be performed by one or more hardware processors configured by machine-readable instructions including a component that is the same as or similar to model training component 110, in accordance with one or more implementations.

An operation 206 may include storing the trained model in non-transitory electronic storage. Operation 206 may be performed by one or more hardware processors configured by machine-readable instructions including a component that is the same as or similar to model storing component 112, in accordance with one or more implementations.

Regarding method 201 (depicted in FIG. 2B), an operation 208 may include managing environment state information maintaining a record management environment. The record management environment may be configured to facilitate interaction by users with the record management environment. Operation 208 may be performed by one or more hardware processors configured by machine-readable instructions including a component that is the same as or similar to environment managing component 128.

An operation 210 may include providing the user information associated with the individual users and the record information from the individual task records as input for the trained model. Operation 210 may be performed by one or more hardware processors configured by machine-readable instructions including a component that is the same as or similar to input providing component 114, in accordance with one or more implementations.

An operation 212 may include obtaining the output from the trained model. Operation 212 may be performed by one or more hardware processors configured by machine-readable instructions including a component that is the same as or similar to output obtaining component 116, in accordance with one or more implementations.

An operation 214 may include generating, from the output, grouping information for the task records, the grouping information defining individual sets of one or more users to be associated with individual task records. The grouping information may be determined based on the output amounts of time and one or more of a subset of the user information and a subset of the record information. Operation 214 may be performed by one or more hardware processors configured by machine-readable instructions including a component that is the same as or similar to group generating component 118, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to train a model to group task records, the system comprising:
non-transitory electronic storage storing model training information, wherein the model training information includes user information associated with individual users and record information from individual task records, wherein user information associated with an individual user includes one or more of a title of the individual user and information characterizing experience of the individual user, wherein individual task records characterize individual tasks managed, created, and/or assigned within a record management environment, wherein a task is a unit of work, wherein record information from an individual task record characterizing an individual task includes one or more of beneficiary information, matter identification information, information characterizing an objective of the individual task, a type of the individual task, information identifying one or more users associated with the individual task, an amount of time of activity toward completion of the individual task by an individual user, and a duration of the individual task; and
one or more physical processors configured by machine-readable instructions to:
obtain the model training information;
train a model using the model training information to generate a trained model, the trained model being configured to output predicted amounts of time of activity associated with completion of individual tasks by individual users completing the individual tasks, wherein the training input information includes the user information associated with the individual users and the record information from the individual task records characterizing individual tasks, wherein the training output information includes amounts of time of activity associated with completion of individual users completing the individual tasks; and
store the trained model in the non-transitory electronic storage.

2. The system of claim 1, wherein the matter identification information identifies an individual matter associated with an individual task.

3. The system of claim 2, wherein beneficiary information identifies an entity associated with the individual matter.

4. The system of claim 1, wherein the duration of an individual task characterizes an amount of time between assignment of the individual user to one or more users and completion of the individual task by the one or more users.

5. The system of claim 1, wherein an amount of time of activity toward completion of an individual task by an individual user is determined based on activity via a client computing platform associated with the individual user.

6. A method for training a model to group task records, the method comprising:
obtaining model training information, wherein the model training information includes user information associated with individual users and record information from individual task records, wherein user information associated with an individual user includes one or more of a title of the individual user and information characterizing experience of the individual user, wherein individual task records characterize individual tasks managed, created, and/or assigned within a record management environment, wherein a task is a unit of work, wherein record information from an individual task record characterizing an individual task includes one or more of beneficiary information, matter identification information, information characterizing an objective of the individual task, a type of the individual task, information identifying one or more users associated with the individual task, an amount of time of activity toward completion of the individual task by an individual user, and a duration of the individual task
training a model using the model training information to generate a trained model, the trained model being configured to output predicted amounts of time of activity associated with completion of individual tasks by individual users completing the individual tasks, wherein the training input information includes the user information associated with the individual users and the record information from the individual task records characterizing individual tasks, wherein the training output information includes amounts of time of activity associated with completion of individual users completing the individual tasks; and
storing the trained model in non-transitory electronic storage.

7. The method of claim 6, wherein the matter identification information identifies an individual matter associated with an individual task.

8. The method of claim 7, wherein beneficiary information identifies an entity associated with the individual matter.

9. The system of claim 6, wherein the duration of an individual task characterizes an amount of time between assignment of the individual user to one or more users and completion of the individual task by the one or more users.

10. The method of claim 6, wherein an amount of time of activity toward completion of an individual task by an individual user is determined based on activity via a client computing platform associated with the individual user.

11. A system configured to group task records, the system comprising:
one or more physical processors configured by machine-readable instructions to:
manage environment state information maintaining a record management environment, the record management environment being configured to facilitate interaction by users with the record management environment, the environment state information including user information associated with individual users and record information from individual task records, wherein user information associated with an individual user includes one or more of a title of the individual user and information characterizing experience of the individual user, wherein individual task records characterize individual tasks managed, created, and/or assigned within a record management environment, wherein a task is a unit of work, wherein record information from an individual task record characterizing an individual task includes one or more of beneficiary information, matter identification information, information characterizing an objective of the individual task, a type of the individual task, information identifying one or more users associated with the individual task, and a duration of the individual task;
provide the user information associated with the individual users and the record information from the individual task records as input for a trained model, the trained model being configured to output predicted amounts of time of activity associated with completion of individual tasks by the individual users completing the individual tasks;
obtain the output from the trained model; and
generate, from the output, grouping information for the task records, the grouping information defining individual sets of one or more users to be associated with individual task records, wherein the grouping information is determined based on the output amounts of time and one or more of a subset of the user information and a subset of the record information.

12. The system of claim 11, wherein the matter identification information identifies an individual matter associated with an individual task, wherein beneficiary information identifies an entity associated with the individual matter.

13. The system of claim 11, wherein the duration of an individual task characterizes an amount of time between assignment of the individual user to one or more users and completion of the individual task by the one or more users.

14. The system of claim 11, wherein an amount of time of activity toward completion of an individual task by an individual user is determined based on activity via a client computing platform associated with the individual user.

15. The system of claim 11, wherein an individual set of one or more users defined by grouping information for an individual task record is determined such that a predicted amount of time of activity associated with completion of the individual task by the one or more users included in the individual set of one or more users is minimized.

16. A method for automatically grouping task records using a machine learning model, the method comprising:
managing environment state information maintaining a record management environment, the record management environment being configured to facilitate interaction by users with the record management environment, the environment state information including user information associated with individual users and record information from individual task records, wherein user information associated with an individual user includes one or more of a title of the individual user and information characterizing experience of the individual user, wherein individual task records characterize individual tasks managed, created, and/or assigned within a record management environment, wherein a task is a unit of work, wherein record information from an individual task record characterizing an individual task includes one or more of beneficiary information, matter identification information, information characterizing an objective of the individual task, a type of the individual task, information identifying one or more users associated with the individual task, and a duration of the individual task;
providing the user information associated with the individual users and the record information from the individual task records as input for the trained model;
obtaining the output from the trained model; and
generating, from the output, grouping information for the task records, the grouping information defining individual sets of one or more users to be associated with individual task records, wherein the grouping information is determined based on the output amounts of time and one or more of a subset of the user information and a subset of the record information.

17. The method of claim 16, wherein the matter identification information identifies an individual matter associated with an individual task, wherein beneficiary information identifies an entity associated with the individual matter.

18. The method of claim 16, wherein the duration of an individual task characterizes an amount of time between assignment of the individual user to one or more users and completion of the individual task by the one or more users.

19. The method of claim 16, wherein an amount of time of activity toward completion of an individual task by an individual user is determined based on activity via a client computing platform associated with the individual user.

20. The method of claim 16, wherein an individual set of one or more users defined by grouping information for an individual task record is determined such that a predicted amount of time of activity associated with completion of the individual task by the one or more users included in the individual set of one or more users is minimized.
